(19) United States
(12) Patent Application Publication
(10) Pub. No.: US 2017/0124505 A1
(43) Pub. Date: May 4, 2017

(54) DISPATCH CONTROLLER AND METHOD FOR ASSIGNING A ROLE OF PURSUIT VEHICLE

(71) Applicant: MOTOROLA SOLUTIONS, INC., Schaumburg, IL (US)

(72) Inventors: Juana E. Nakfour, Hawthorn Woods, IL (US); Trent J. Miller, West Chicago, IL (US); Lee M. Proctor, Cary, IL (US)

(21) Appl. No.: 14/931,570

(22) Filed: Nov. 3, 2015

(51) Int. Cl. G06Q 10/06

(52) U.S. Cl. CPC G06Q 10/063112

(57) ABSTRACT

A method and dispatch controller for assigning roles to responder units in a suspect pursuit. The method and controller include determining that the suspect pursuit is active and identifying a first responder unit as a pursuit unit to pursue the suspect. In response to a reevaluation trigger, the method and dispatch controller determine to reevaluate assignment of the pursuit unit. The reevaluation may occur, for example, when the pursuit unit is blocked by traffic or otherwise is separated from the suspect. Characteristic data is received regarding the responder units in response to the reevaluation trigger. The characteristic data is then evaluated to determine a suitability level of each of the responder units to be the pursuit unit. When the second responder unit has a higher suitability level than the first responder unit, the second responder unit is substituted as the pursuit unit.

### BACKGROUND OF THE INVENTION

Law enforcement agencies in jurisdictions around the world will occasionally engage in pursuit of a suspect. For example, a law enforcement officer may observe potential traffic infractions, such as a vehicle traveling at a speed in excess of a speed limit, and signal to the vehicle operator to pull to the side of the road by enabling emergency lights and sirens on the officer's vehicle. Generally, the vehicle operator will pull to the side of the road and stop shortly thereafter such that the officer may engage the operator and address the potential infraction. However, in some instances, the vehicle operator does not follow the direction from the officer to pull to the side of the road and, instead, flees. In such instances, a suspect pursuit may occur whereby the law enforcement officer pursues or chases the fleeing suspect vehicle. Other officers may join in the pursuit as well.

While the example provided relates to a traffic violation, a suspect may flee, and an officer may pursue the suspect, for a variety of reasons. For example, the officer may recognize the suspect as being wanted for a previous offense or the officer may witness the suspect engaged in criminal activity.

Regardless of the cause, a suspect pursuit generally includes a law enforcement officer pursuing a suspect that is evading the officer. A suspect pursuit may also occur by foot, bike, horse, vehicle, another mode of transportation, or a combination thereof (e.g., suspect on foot and pursuing officer in vehicle). A suspect pursuit may also include an unmanned drone aircraft.

Suspect pursuits present challenges to law enforcement agencies and the public. For example, a fleeing suspect may operate a vehicle at a high rate of speed and drive erratically, putting other vehicles and pedestrians at risk for collision and harm. Coordinating pursuit of a suspect by a number of officers is challenging because of the continuously changing variables of the pursuit, such as the position of the suspect, position and number of officers involved, traffic, and environmental conditions. Further challenges are presented through the lack of clear roles for the various officers involved, which can impede effectiveness and success rate in apprehending the suspect.

Accordingly, there is a need for an improved dispatch controller and method for assigning roles to officers in a suspect pursuit and providing a coordinated pursuit strategy to the officers to improve the safety, efficiency, and effectiveness of suspect pursuits.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a pursuit dispatch system in accordance with some embodiments.

FIG. 2 illustrates a responder unit of the pursuit dispatch system of FIG. 1 in accordance with some embodiments.

FIG. 3 illustrates an external data server of the pursuit dispatch system of FIG. 1 in accordance with some embodiments.

FIG. 4 illustrates a dispatch controller of the pursuit dispatch system of FIG. 1 in accordance with some embodiments.

FIG. 5 is a flowchart of a method of assigning roles to responder units in a suspect pursuit and for coordinating a suspect pursuit strategy in accordance with some embodiments.

FIG. 6 is a flowchart of a method of identifying a pursuit vehicle in accordance with some embodiments.

FIG. 7 is a flowchart of a method of providing a coordinated pursuit strategy in accordance with some embodiments.

FIG. 8 is a pursuit diagram illustrating a coordinated pursuit strategy in accordance with some embodiments.

FIGS. 9A and 9B are pursuit diagrams illustrating substituting a pursuit unit in a suspect pursuit in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In one embodiment, the invention provides a method of assigning roles to responder units in a suspect pursuit. The method includes determining that the suspect pursuit is active, the suspect pursuit including pursuit of a suspect. The method further includes identifying a first responder unit of the responder units as a pursuit unit to pursue the suspect, and determining, in response to a reevaluation trigger, to reevaluate assignment of the pursuit unit. The method also includes receiving, by a processor, characteristic data regarding the responder units in response to the reevaluation trigger. The method further includes evaluating, by the processor, the characteristic data to determine a suitability level of each of the responder units to be the pursuit unit. The processor substitutes a second responder unit as the pursuit unit based on the suitability levels.

In another embodiment, the invention provides a dispatch controller including a transceiver, a processor coupled to the transceiver, and a memory coupled to the processor. The memory contains instructions that, when executed by the processor, perform a set of functions. The set of functions includes determining that the suspect pursuit is active, the suspect pursuit including pursuit of a suspect, and identifying a first responder unit of the responder units as a pursuit unit to pursue the suspect. The method further includes determining, in response to a reevaluation trigger, to reevaluate assignment of the pursuit unit, and receiving, by a processor, characteristic data regarding the responder units in response to the reevaluation trigger. The method also includes evaluating, by the processor, the characteristic data to determine a suitability level of each of the responder units to be the pursuit unit and, further, substituting, by the processor, a second responder unit as the pursuit unit based on the suitability levels.

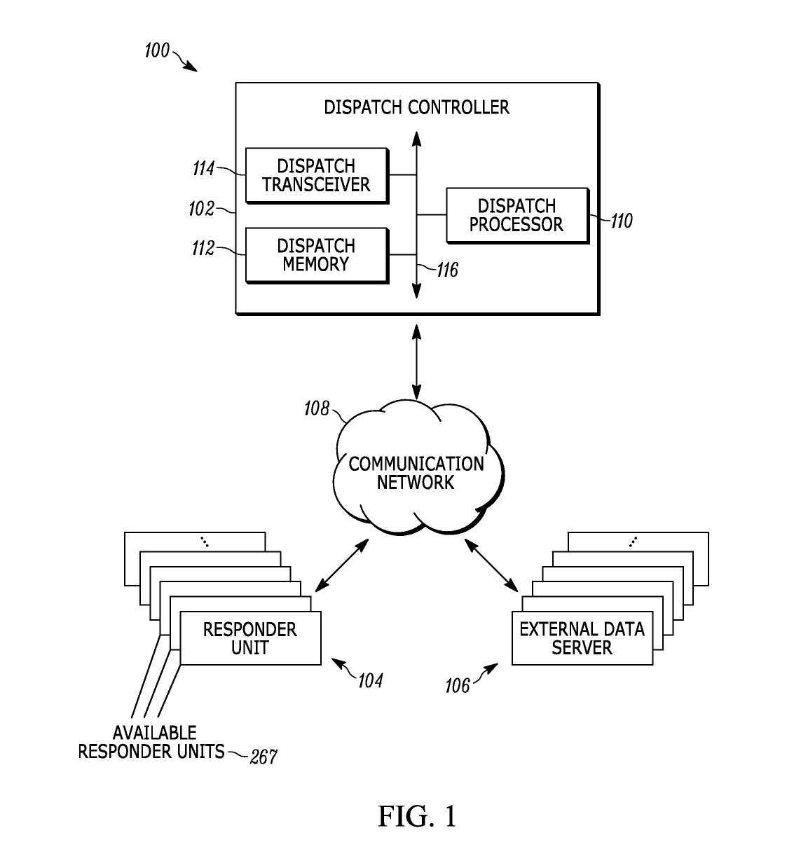

FIG. 1 illustrates a pursuit dispatch system 100 including a dispatch controller 102, responder units 104, and external data servers 106 connected by a communication network 108. The dispatch controller 102 includes a dispatch processor 110, which is an electronic processor, a dispatch memory 112, and a dispatch transceiver 114. The dispatch processor 110, dispatch memory 112, and dispatch transceiver 114 are coupled by a dispatch communication bus 116. The dispatch memory 112 is a nontransitory memory that stores instructions that are received and executed by the dispatch processor 110 to carry out the functionality of the dispatch controller 102 described herein. The dispatch transceiver 114 enables the dispatch controller 102 to communicate with other devices including the responder units 104 and the external data servers 106 via the communication network 108. In some embodiments, the dispatch controller 102 is or is incorporated into an application server (not shown).

The communication network 108 may be a wide area telecommunication system network or another wide area network (WAN) including a public or private network, or a combination of private and public networks. The communication network 108 may include landline telephone lines, cellular networks, land-mobile radio networks, local area data networks, wide area networks, and or any other communications network type. The communication network 108 may include or have one or more connections to the public switched telephone network (PSTN) and the Internet. The communication network 108 may switch or route network traffic, including voice telephone calls (e.g., cellular and landline calls), digital and analog radio communications, voice over internet protocol (VoIP), short message service (SMS) messages and multimedia message service (MMS) messages (collectively referred to herein as “text messages”), transmission control protocol/internet protocol (TCP/IP) data traffic, and the like.

Each of the responder units 104 is generally associated with a human responder (e.g., a law enforcement officer) and a mode of transportation (e.g., on foot, bicycle, vehicle, helicopter, unmanned aerial vehicle, horse, and the like). For example, the responder unit 104 may be a device worn by an officer on foot or incorporated into or nearby a dash of an officer vehicle (e.g., car, sports utility vehicle (SUV), or truck). While the description herein generally refers to officers being involved in a suspect pursuit or associated with a responder unit, human responders other than officers may be involved in the pursuit or associated with a responder unit.

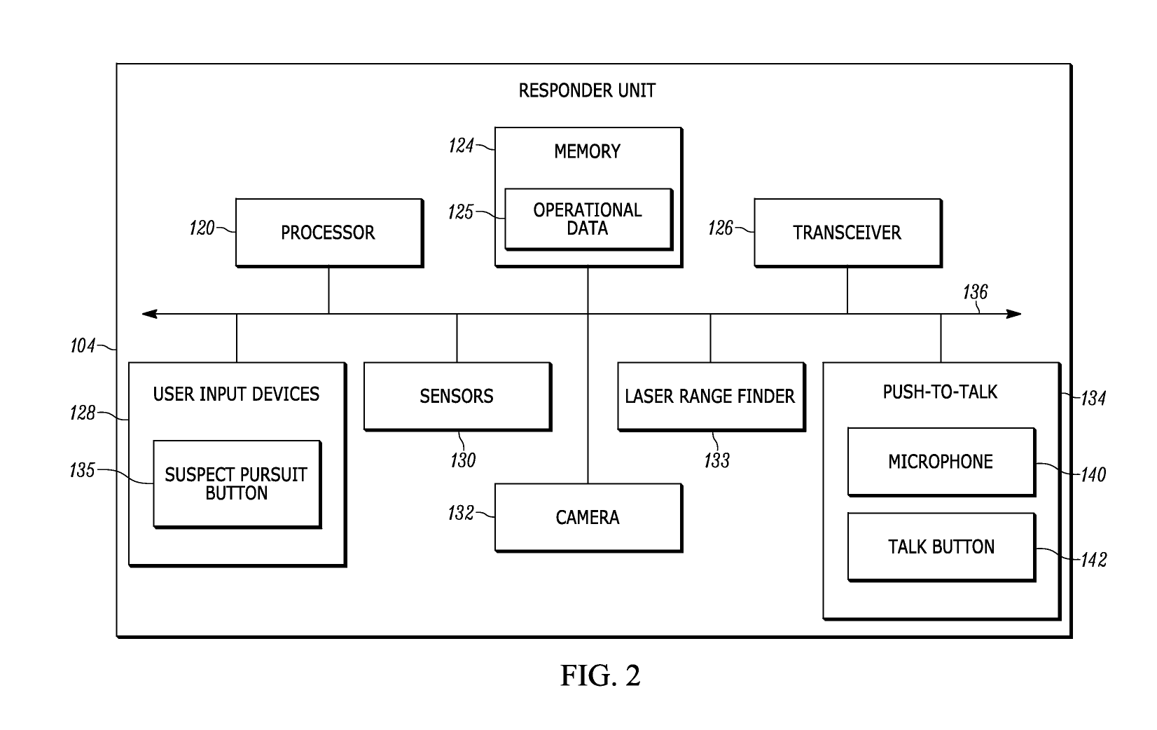

One example of the responder unit 104 is illustrated in greater detail in FIG. 2. In some embodiments, one or more of the responder units 104 may include additional, fewer, or modified elements relative to that which is shown in FIG. 2. In FIG. 2, the responder unit 104 includes a processor 120, which is an electronic processor, a memory 124, a transceiver 126, user input devices 128, sensors 130, a camera 132, a laser range finder 133, and a push-to-talk (PTT) unit 134, which are coupled via a communication bus 136. The memory 124 is a nontransitory memory that stores instructions that are received and executed by the processor 120 to carry out the functionality of the responder unit 104 described herein. The memory 124 may also store operational data 125 including audio-visual data from the camera 132, audio visual analytics data from software analysis of the audio-visual data, distance data from the laser range finder 133, sensor data from the sensors 130, responder information data, and other operational data. For example, the operational data 125 may include one or more of siren status data, emergency lights data, vehicle speed data, vehicle acceleration data, user voice data, image data, video data, audio-visual analytics data, or any other data associated with the operation of the responder unit 104, some of which are described in further detail below. The transceiver 126 enables the responder unit 104 to communicate with other devices, for example, the dispatch controller 102 via the communication network 108.

The user input devices 128 may include, for example, keyboards, touch screens, switches, and other input components that enable the responder unit 104 to receive user input. For example, as illustrated, the user input devices 128 include a suspect pursuit button 135. When the suspect pursuit button 135 is pressed, the responder unit 104 outputs a signal to the dispatch controller 102 indicating that a suspect pursuit is active. Accordingly, in this example, the dispatch controller 102 receives a user-entered notification that the suspect pursuit is active.

The sensors 130 include one or more sensors generating sensor data, which is stored as part of the operational data 125. The operational data 125 is accessible by the processor 120. The sensors 130, for example, may include one or more of the following: a global positioning satellite (GPS) receiver providing location and movement data of the responder unit 104, accelerometers providing movement data along one or more axes of the responder unit 104, fuel level sensors providing data indicating a fuel level of a vehicle associated with the responder unit 104, speed sensor(s) providing data indicating a speed of a vehicle associated with the responder unit 104, emergency light sensor(s) providing data indicating whether emergency lights of a vehicle associated with the responder unit 104 are enabled, and siren sensor(s) providing data indicating whether a siren of a vehicle associated with the responder unit 104 is enabled. Some of these sensors may be installed separately from a responder unit 104 in an officer vehicle (e.g., at the time of manufacture or via other third party install) associated with the responder unit 104, but separate from the responder unit 104. In these instances, the responder unit 104 may be coupled to a vehicle communication network (e.g., a controller area network (CAN) bus) to receive the sensor data.

The camera 132 may include both an image and video capturing device and an audio capturing device, which provide one or more of still image data, audio data, textual data, and video data, generally referred to as audio-visual data, which may be stored as part of the operational data 125 in the memory 124 and accessed by the processor 120. The processor 120 executes one or more of image, audio, textual, and video analysis software to analyze the audio-visual data and provide analytics data. The analysis can be used, for example, to recognize suspect vehicles via license plate recognition, to recognize reckless driving of suspect vehicles, to estimate distance to suspect vehicles, and to detect audio commands via speech recognition. The results of the analysis of the audio-visual data may be referred to as audio-visual analytics data, generally. More specifically, the results of analysis of audio data may be referred to as audio analytics, the results of the analysis of textual data may be referred to as textual analytics, and the results of the analysis of video and image data may be referred to as video analytics. The operational data 125 may include the raw audio-visual data, the audio-visual analytics data generated from analysis of the audio-visual data, or both.

The laser range finder 133 includes a laser transmitter and detector used to measure distance and relative speed between the laser range finder 133 and an object, such as a suspect vehicle. Accordingly, the laser range finder 133 is operable to provide distance data and relative speed data to the processor 120 to indicate a distance and a difference in speed between the responder unit 104 and the suspect.

The push-to-talk unit 134 enables a user (e.g., an officer) to communicate to other responder units 104 and the dispatch controller 102. The push-to-talk unit 134 includes a microphone 140 and a talk button 142. In response to the talk button 142 being depressed, the microphone 140 is enabled and audio captured by the microphone 140 is sent over a communication channel to recipient units (e.g., other responder units 104 and the dispatch controller 102). The audio data, which generally includes user-voice data, may also be stored as part of the operational data 125 and analyzed by the processor 120 executing analysis software as described above with respect to the audio-visual data.

The operational data 125 may further include responder information data, such as the mode of transportation of the responder unit 104 (e.g., vehicle-based, person-based, bicycle-based, helicopter-based, unmanned-vehicle-based), responder or officer characteristics (e.g., age, fitness level, overall health, skill set, and experience level), maximum speed of vehicle, health of vehicle, vehicle make, vehicle model, and other information related to the responder unit 104.

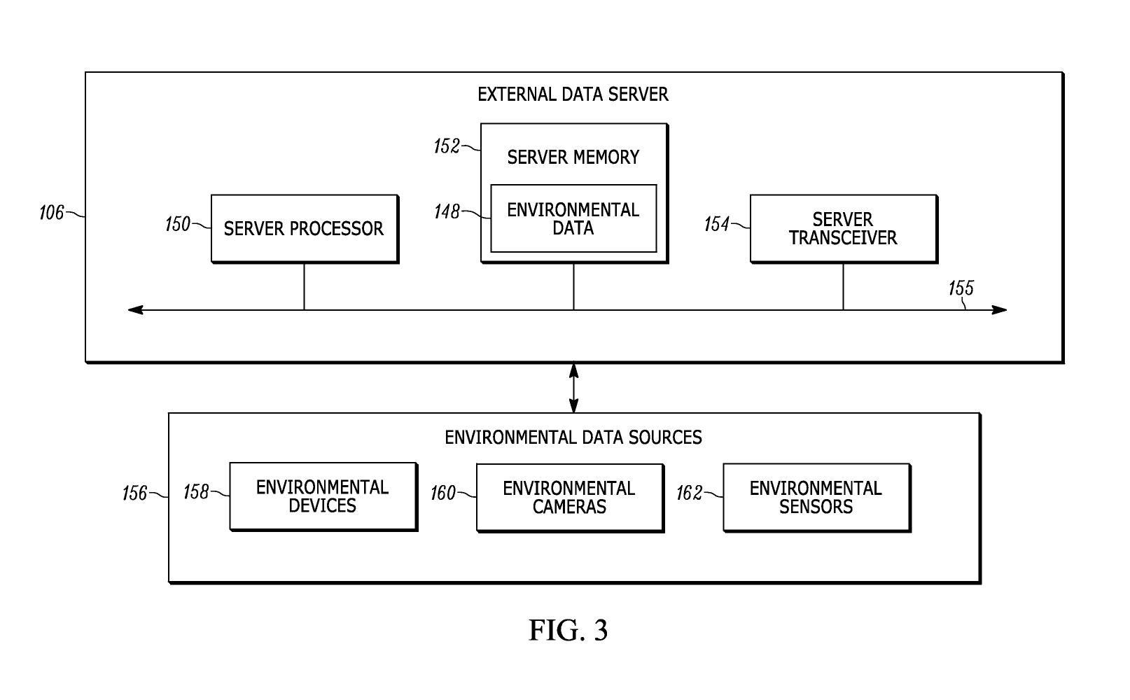

FIG. 3 illustrates one example of the external data servers 106 in further detail. In some embodiments, one or more of the external data servers 106 may include additional, fewer, or modified elements relative to that which is shown in FIG. 3. The external data server 106 collects, stores, and provides environmental data 148 to the dispatch controller 102. The external data processor 106 includes a server processor 150, which is an electronic processor, a server memory 152, and a server transceiver 154. The server processor 150, server memory 152, and server transceiver 154 are coupled by a server communication bus 155. The external data server 106 is coupled to one or more environmental data sources 156 that provide captured environmental data 148 to the server memory 152, which is a nontransitory memory. The environmental data sources 156 include, for example, one or more of environmental devices 158, environmental cameras 160, and environmental sensors 162. The environmental data 148 includes various information including one or more of the following: traffic light data, topography data, road condition and status data, and weather data.

The environmental devices 158 include, for example, traffic light controllers that provide traffic light status and traffic information and that may be controlled via requests from the dispatch controller 102 or the responder units 104. The environmental cameras 160 include, for example, digital cameras aimed at various roadways to provide image data of the roadways, which can be analyzed by the server processor 150 to provide traffic, weather, and road condition data. The environmental sensors 162 include, for example, traffic sensors that provide traffic data, weather sensors that provide weather data (e.g., temperature and precipitation levels), and light sensors indicating an amount of day light. In some examples, one or more of the external data servers 106 are public data sources maintained and updated by government agencies (e.g., a department of transportation) or by other third parties.

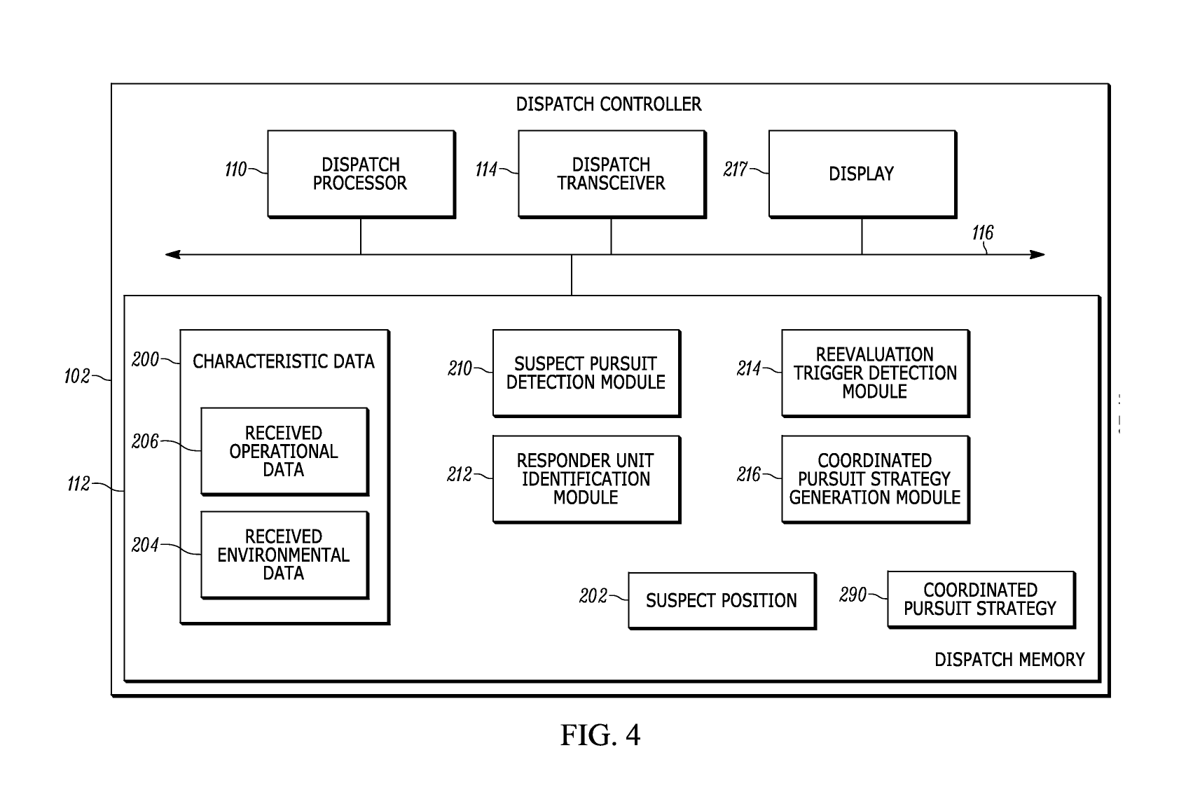

FIG. 4 illustrates one example of the dispatch controller 102 in further detail. In some embodiments, the dispatch controller 102 may include additional, fewer, or modified elements relative to that which is shown in FIG. 3. The dispatch memory 112 stores data from various sources for use in systems and methods described herein, including characteristic data 200 and a suspect position 202. The characteristic data includes received environmental data 204 and received operational data 206. The received environmental data 204 is received from the external data servers 106 and includes the environmental data 148. The received operational data 206 is received from the responder units 104 and includes the operational data 125. The dispatch memory 112 further includes several modules that are, for example, instruction segments for execution by the dispatch processor 110 to carry out functionality of the modules described herein. More particularly, the dispatch memory 112 includes a suspect pursuit detection module 210, responder unit identification module 212, reevaluation trigger detection module 214, and coordinated pursuit strategy generation module 216. The data and blocks of the memory 112 are described in greater detail below.

The dispatch controller 102 may further include a display 217. The processor 110 may control the display 217 to show information about a suspect pursuit, as well as other information within the dispatch memory 112 (e.g., the characteristic data 200 or the suspect position 202). In some instances, the display 217 is part of another computing device coupled to the dispatch controller 102 directly or via a network.

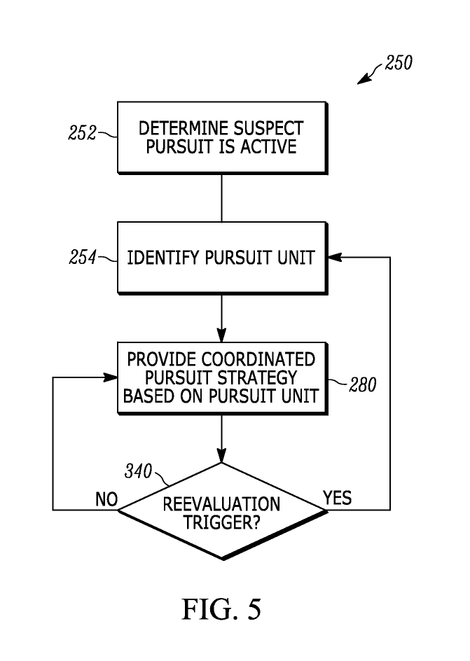

FIG. 5 illustrates a method 250 for assigning roles to responder units in a suspect pursuit and for coordinating a suspect pursuit strategy for a plurality of responder units. The method 250 may be used to apprehend a fleeing suspect in an efficient manner while reducing opportunities for damage to persons and property. The method 250 is described with reference to the pursuit dispatch system 100, although other systems and components may be used to implement the method 250 in some embodiments. The method 250 includes the dispatch controller 102 determining that a suspect pursuit is active (block 252). For example, the dispatch processor 110, executing the suspect pursuit detection module 210, determines that a suspect pursuit is active based on analyzing data from responder units 104, such as the received operational data 206. More particularly, the dispatch processor 110 may determine that a suspect pursuit is active based on receiving from one of the responder units 104 operational data 125 including siren status data and emergency light status data and determining, based on the operational data 125, that a suspect pursuit is active. For example, the siren status data may indicate whether sirens of a law enforcement vehicle are enabled, the emergency light status data may indicate whether the emergency lights of the law enforcement vehicle are enabled. The operational data 125 used in the determination may also indicate the speed, acceleration, and direction of the law enforcement vehicle. As one example, the dispatch processor 110 may analyze this received data and determine that a suspect pursuit is active when the sirens and emergency lights are indicated as active, and the speed of the law enforcement vehicle is in excess of a predetermined threshold for a predetermined amount of time.

The dispatch processor 110 may determine a suspect pursuit is active using additional techniques as well. For example, the dispatch processor 110 may receive a pursuit notification from the responder unit 104 in response to an officer engaging the suspect pursuit button 135 of the responder unit 104.

Additionally, the dispatch processor 110 may determine that a suspect pursuit is active through audio processing analysis of audio received via the microphone 140 of the push-to-talk unit 134. For example, an officer may state a predetermined phrase, such as “in pursuit of suspect” or “10-50” while depressing the talk button 142. The phrase is captured by the microphone 140 and transmitted as audio data to the dispatch controller 102, which uses voice recognition software (e.g., within the suspect pursuit detection module 210) to recognize the predetermined phrase. Upon recognition of the predetermined phrase, the dispatch processor 110 determines that a suspect pursuit is active. In some instances, the dispatch processor 110 determines that a suspect pursuit is active based on both recognizing the predetermined phrase and determining that the emergency lights and siren are enabled.

In some embodiments, the dispatch processor 110 determines that a suspect pursuit is active based on determining that the emergency lights and siren are enabled and further determining, based on image or video data from the camera 132, that a suspect vehicle is being followed. For example, image analysis software may indicate that a particular vehicle, based on license plate recognition, has been in the image frames for a certain period of time while the emergency lights and sired are enabled.

In some embodiments, the dispatch processor 110 determines that a suspect pursuit is active based on information that is dependent on the mode of transportation of the responder unit 104. For example, if the responder unit 104 is associated with an officer on-foot, the dispatch processor 110 may determine that a suspect pursuit is active when sensor data output by accelerometers or a GPS receiver of the sensors 130 indicate that the officer is running. The dispatch processor 110 may make the determination that a suspect pursuit is active based on detecting that the officer is running in combination with another indication, such as detection via audio software analysis of a particular phrase (e.g., “in pursuit”) spoken by the officer while depressing the talk button 142 of FIG. 2.

After a suspect pursuit has been determined to be active, the dispatch controller 102 proceeds to identify a pursuit unit (block 254). The pursuit unit is a label assigned to one of the responder units 104 involved in a suspect pursuit. In some embodiments, the dispatch controller 102 may identify, as the pursuit unit, the responder unit 104 that caused the determination that the suspect pursuit is active in block 252. In other words, in these embodiments, generally, the officer that first identified a fleeing suspect and initiated pursuit would have his or her associated responder unit 104 initially identified as the pursuit unit. As part of the identification, the dispatch controller 102 may transmit a notification to the responder unit 104 that it has been designated as the pursuit unit.

Once labeled as the pursuit unit, the responder unit 104 may be given priority in one or more systems. For example, the pursuit unit may have priority for quality of service (QoS) over communication networks or for traffic light control. With respect to priority for quality of service, as an example, the communication network 108 may provide additional bandwidth or other resources, relative to a peer unit, to improve or increase the likelihood of uncorrupted, fast communications over the communication network 104 between the pursuit unit and the dispatch controller 102 or other responder units 104. With respect to traffic light control, the responder unit 104 that is the pursuit unit may provide the dispatch unit 102 with heading information, and the dispatch unit 102 may communicate with the external data servers 106 coupled to a traffic light network to control the traffic light network. For example, the dispatch unit 102 may provide commands to the traffic light network such that the traffic lights that the pursuit unit is approaching provide the pursuit unit the right-of-way (i.e., turn green). In some embodiments, the responder unit 104 designated the pursuit unit may communicate with a traffic light directly via local radio-frequency (RF) communications to command that a traffic light provide the pursuit unit the right-of-way and include a pursuit unit identification with the command. In contrast, a similar command from one of the responder units 104 that is not labeled the pursuit unit may be given lower priority or ignored by the traffic light.

The pursuit dispatch system 100 may assign a higher priority to the pursuit unit in other ways as well. For example, the display 217, which may be showing pursuit information (e.g., estimated suspect position on a map, the responder units 104 involved, or elapsed time of the pursuit), may be controlled to display or highlight information about the pursuit unit based on its designation as pursuit unit. In contrast, information about the other responder units 104 may be less visually apparent or not shown at all on the display 217. This highlighting prioritizes the information for easier consumption by law enforcement individuals monitoring the suspect pursuit. For example, the display 217 may show fuel level, speed, and other information about the pursuit unit obtained from the received operational information 206, while not showing similar information about the other responder units 104, or showing similar information in a smaller font or other less visually apparent manner.

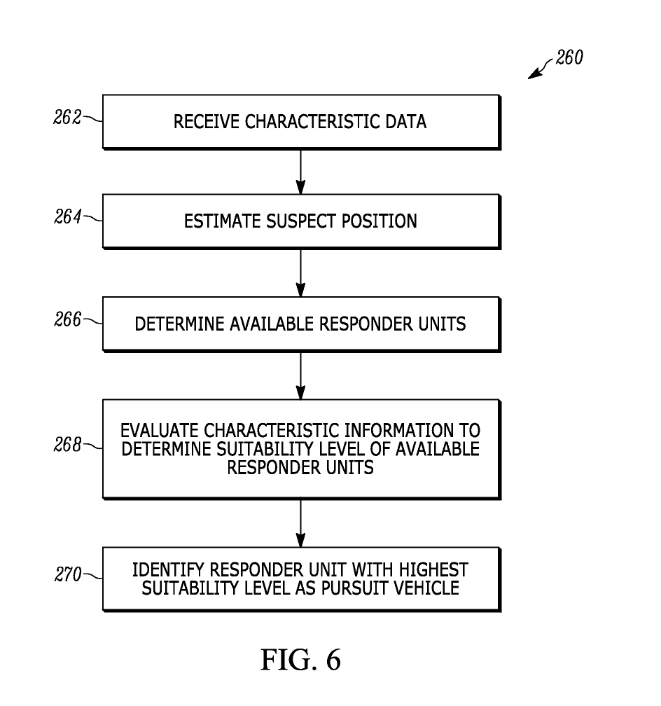

In another example, the dispatch controller 102 may control the display 217 to provide a map that has real-time or near real-time plotting of the suspect pursuit. The plotting of the suspect pursuit includes a map illustrating the location and heading of the responder units 104 that are involved in the pursuit and of the fleeing suspect. This location and heading information for the responder units 104 may be part of the received operational data 206 provided to the dispatch controller 102 and the suspect location and heading can be estimated, for example, using data from the pursuit unit, as is discussed in further detail below (e.g., with respect to FIG. 6). On the map, the responder unit 104 that is designated as the pursuit unit may be highlighted using a different color or size graphic than the other responder units 104.

The dispatch controller 102 may further highlight data provided by the pursuit unit in an event log maintained based on the characteristic data 200 received. The event log may record time, location, involved responder units, and other information from the characteristic data 200 over the course of a suspect pursuit. Within the event log, more information from the pursuit unit may be logged than from the other responder units 104 involved in the suspect pursuit, or the information from the pursuit unit may be highlighted through a font difference or other indication relative to the information from the other responder unit 104.

In some embodiments, the responder unit 104 that receives a notification that it has been designated as the pursuit unit may control devices associated with the responder unit 104. For example, the responder unit 104 designated as the pursuit unit may enable the camera 132 to capture audio-visual data of the pursuit, or may specify that the camera 132 increase the resolution of audio-visual data already being captured. Similarly, upon removal of the designation as pursuit unit, the responder unit may disable the camera 132 or return the camera 132 to a lower resolution capture of audio-visual data. In some embodiments, in response to a pursuit unit designation, the responder unit 104 may provide audio-visual data (e.g., from the camera 132) to the dispatch controller 102 or may broadcast the audio-visual data via the communication network 108 to other responder units 104.

In some embodiments, the dispatch controller 102 considers several factors before assigning the pursuit unit label to one of the responder units 104. FIG. 6 illustrates a method 260 for identifying a pursuit unit that may be used to implement block 254 of the method 250. For example, the dispatch processor 110, executing the responder unit identification module 212, may implement method 260 to identify a pursuit unit. In block 262, the dispatch controller 102 receives the characteristic data 200, which includes one or both of the received operational data 206 from the responder units 104 and the received environmental data 204 from the external data servers 106.

In block 264, the suspect position 202 (FIG. 4), including one or more of a location, speed, and direction of travel for the suspect, is estimated for the suspect. One or more of the location, speed, and direction of travel of the suspect may be referred to and stored as the suspect position 202. Initially, location, speed, and direction of travel of the responder unit 104 that initiated the suspect pursuit determination (block 254) may be used as a proxy for the suspect position 202. In future iterations of the block 264 during the same suspect pursuit, the location, speed, and direction of travel of the responder unit 104 currently identified as the pursuit unit may be used as the suspect position 202. Accordingly, in some embodiments, the dispatch controller 102 estimates a location of the suspect based on location data from the pursuit unit or another of the responder units 104 that initiated the suspect pursuit.

In some embodiments, the suspect position 202 is determined based on additional information provided by one of the responder units 104. For example, one of the responder units 104 nearby a suspect may use a targeting device (e.g., the laser range finder 133) that is aimed and triggered by an associated officer to provide relative distance and speed measurements between the suspect vehicle and the responder unit. The relative distance and speed determination can be provided to the dispatch controller 102 in addition to the location, speed, and direction of travel data for the responder unit 104, and the dispatch controller 102 can calculate a more precise suspect position 202 using this information.

In some embodiments, video analysis software of the responder unit 104, such as automated license plate recognition (ALPR) software or analysis software that can identify unique vehicle visual markers to distinguish a particular suspect vehicle from other vehicles, provides a relative distance and speed determination to the dispatch controller 102. In some embodiments, the video analysis software works in conjunction with the laser range finder 133 such that the video analysis software identifies a suspect vehicle (e.g., based on license plate or unique vehicle characteristic) and the laser range finder 133 provides a relative distance and speed to the identified suspect vehicle. The relative distance and speed determination can be provided to the dispatch controller 102 in addition to the location, speed, and direction of travel data for the responder unit 104, and the dispatch controller 102 can calculate a more precise suspect position 202 using this information.

In some embodiments, video analysis software analyzing video from a fixed street camera (e.g., at a toll way), an unmanned aerial vehicle, or both provides information about the location of the suspect vehicle. For example, automated license plate recognition (ALPR) software analyzing video from a fixed street camera may detect a license plate of the suspect vehicle. Combining this detection with a known location of the fixed street camera indicates to the dispatch controller 102 that the suspect vehicle is at the location of the fixed street camera. Automated license plate recognition (ALPR) software may also detect the license plate of a suspect vehicle in video captured by a camera on an unmanned aerial vehicle (e.g., drone aircraft). The detection, in combination with location and camera direction information from the unmanned aerial vehicle, indicates to the dispatch controller 102 an estimated location of the suspect vehicle.

In block 266, the dispatch controller 102 determines a portion of the responder units 104 that are available for pursuit of the suspect. The responder units 104 that are available are a subset of the responder units 104 and are referred to as available responder units 267 (see FIG. 1). The available responder units 267 may include those responder units 104 that are already engaged in pursuit of the suspect as well as those responder units 104 that are nearby the suspect. For example, the dispatch controller 102 may compare the most recent location data in the received operational data 206 received for each of the responder units 104 (from block 262) and the suspect position 202 (from block 264) and determine a distance between each responder unit 104 and the suspect position 202. For each responder unit 104 that is less than a predetermined distance from the suspect position 202, these responder units 104 are considered available responder units 267. Accordingly, identifying the available responder units 267, in this example, includes using an estimated location of the suspect (the suspect position 202), receiving the operational data 125 including location data for the responder units 104, and identifying a portion of the responder units 104 within a predetermined distance of the estimated location of the suspect as the available responder units 267.

The operational data 125 may also indicate whether a responder unit 104 is presently involved in other activity (e.g., a traffic stop of another vehicle). In such a case, the preoccupied responder units 104 may be considered unavailable responder units despite being within the predetermined distance of the suspect position 202.

Furthermore, those responder units 104 that are already involved in the pursuit of the suspect, but which are not identified as the pursuit unit, are also considered available responder units 267. For example, the dispatch controller 102 may determine that certain of the responder units 104 are already involved in the suspect pursuit by determining that the responder units 104 are currently involved in a suspect pursuit (see, e.g., block 252) and are within a certain distance of the suspect position 202. These responder units 104 are then identified as at least some of the available responder units 267.

In block 268, the dispatch controller 102 evaluates the characteristic data 200 to determine a suitability level of each of the available responder units 267 to be the pursuit unit. In evaluating the characteristic data 200 to determine a suitability level, the dispatch controller 102 calculates a score for each of the available responder units 267. The score is a quantity or ranking computed based on various factors, which is described in greater detail below. In block 270, the available responder unit 267 having the highest suitability level (i.e., score) is identified as the pursuit unit. The other available responder units 267 are identified as peer units.

The score calculated by the dispatch controller 102 for each available responder unit 267 is based on one or more of the following example factors: transportation mode, maximum speed, current speed, defensive capabilities, vehicle health, fuel remaining, vehicle make, vehicle model, vehicle size, vehicle armament, distance to suspect, operator experience, driver/operator skill set, unit time-in-shift, and environmental parameters (e.g., traffic light status, topography, road conditions and status, and weather). For example, if the distance between a suspect and (a) a first of the responder units 104 and (b) a second of the responder units 104 is approximately equal, but the first of the responder units 104 has more fuel, a higher maximum speed, and a more experienced driver, the dispatch controller 102 will assign the first of the responder units 104 a higher score and it will be identified as the pursuit unit. Generally, a higher score will result from a shorter distance to the suspect, more fuel, a higher maximum speed, better health, newer vehicle or unit, and more experience. Additionally, a higher score will result from fewer environmental obstacles between the responder unit 104 and the suspect, such as fewer red lights, smaller difference in altitude, less traffic, less hazardous (e.g., icy) roads, and less inclement weather.

Returning to FIG. 5, after one of the responder units 104 is identified as the pursuit unit, the dispatch controller 102 provides a coordinated pursuit strategy to a selection of the responder units 104 including the pursuit unit and one or more of the available responder units 267 (block 280). For example, the dispatch processor 110, executing the coordinated pursuit strategy module 216, may implement the block 280 to provide the coordinated pursuit strategy. Providing the coordinated pursuit strategy may include providing a pursuit label notification to the pursuit unit and instructions to continue to follow the suspect. Providing the coordinated pursuit strategy may further include providing a peer label notification to one or more of the available responder units 267 as well as navigation directions to an intercept point particular to each such responder unit 104. FIG. 4 illustrates a coordinated pursuit strategy 290 that was generated by the dispatch controller 102 and stored in the memory 112, and that may be provided over the communication network 108 to the responder units 104.

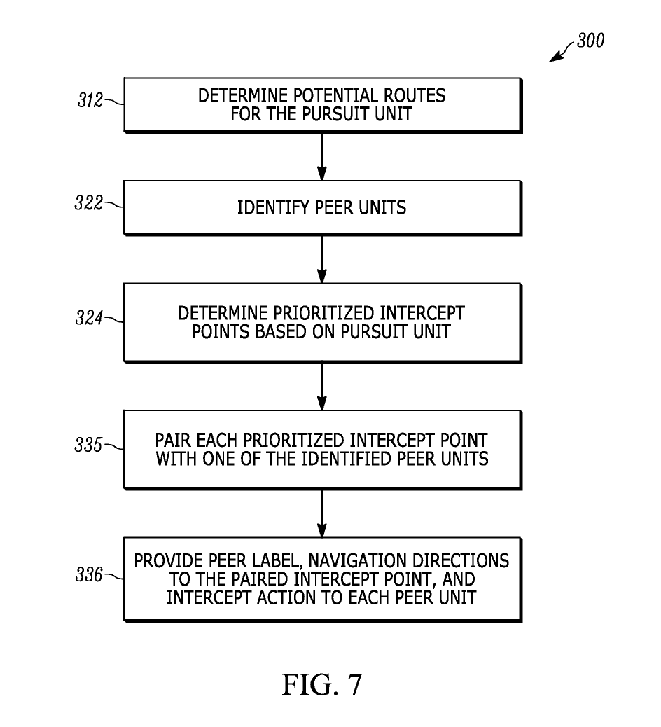

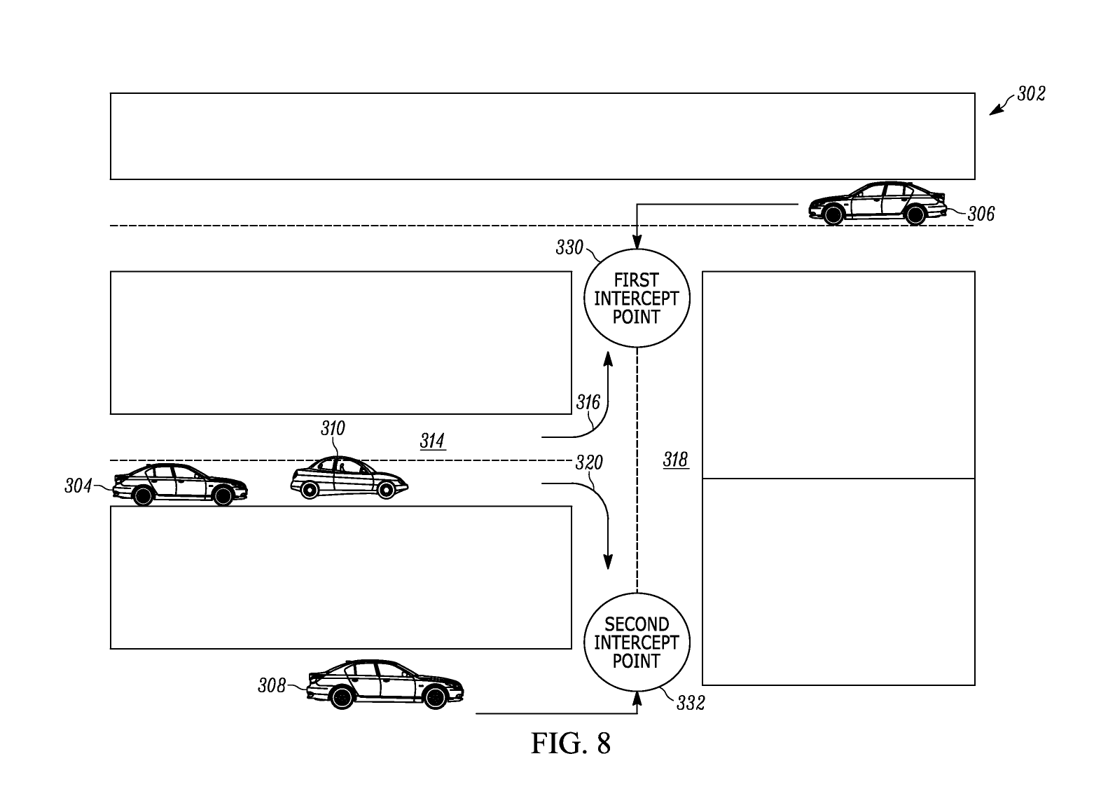

FIG. 7 illustrates a method 300 of providing the coordinated pursuit strategy 290 that may be used to implement the block 280 of FIG. 5. The method 300 will be described with reference to the pursuit diagram 302 of FIG. 8. The pursuit diagram 302 illustrates a pursuit vehicle 304, a first peer vehicle 306, a second peer vehicle 308, and a suspect vehicle 310. The suspect vehicle 310 has been identified as a suspect vehicle by the dispatch controller 102 in, for example, block 252 of the method 250 (FIG. 5). The pursuit vehicle 304 incorporates one of the responder units 104, which has been identified as the pursuit unit using, for example, the method 260.

Returning to FIG. 7, the dispatch controller 102 determines potential routes for the pursuit vehicle 304 (block 312). For example, for the determination, the dispatch controller 102 uses mapping software and received location, speed, and direction of travel information in the received operational data 206 provided by the responder unit 104 of the pursuit vehicle 304. The potential routes may be ranked according to likelihood of travel based on, for example, traffic light information of the routes, speed limits of routes, numbers of lanes of routes, traffic along the routes, and other information of the received environmental data 204 that is received from the external data servers 106. As an example, a shorter route with less traffic would generally be more likely to be traveled than a longer route with more traffic. The potential routes are used as a proxy for the potential routes of the suspect vehicle 310. Accordingly, block 312 may also be described as determining of potential routes for the suspect vehicle 310 based on determining potential routes for the pursuit vehicle 304. Additionally or alternatively, in block 312, the dispatch controller 102 may determine potential routes for the suspect vehicle 310 based on an estimated suspect position (see block 264 of FIG. 6), which itself may be based on the received location, speed, and direction of travel information of the pursuit vehicle 304.

Turning to FIG. 8, the pursuit vehicle 304 is traveling along initial road 314 and two potential routes may be determined in block 312: a first route 316 turning left upon reaching the t-intersection 318 and a second route 320 turning right upon reaching the t-intersection 318.

Returning to FIG. 7, the dispatch controller 102 identifies peer units (block 322), including the first peer vehicle 306 and the second peer vehicle 308. The peer units are identified by, for example, selecting all or a set of the available responder units 267 from step 266 (FIG. 6) as the peer units. The selected set of the available responder units 267 may be a predetermined number of the nearest or otherwise most suitable of the available responder units 267 for engaging in the suspect pursuit.

In block 324, the dispatch controller 102 uses one or more of the location, speed, and direction of travel of the pursuit unit to determine prioritized intercept points along the potential routes of the pursuit unit determined in block 312. For example, in FIG. 7, the dispatch controller 102 determines first intercept point 330 and second intercept point 332, with the first intercept point 330 being a higher priority based on, for example, information from external data servers 106 indicating that the suspect is more likely to follow the first route 316. Other factors considered by the dispatch controller 102 in prioritizing intercept points may include environmental conditions, such as traffic, construction, road conditions, population level nearby, and danger. The dispatch controller 102 would generally assign a higher priority level to an intercept point that has lower traffic, less construction, clearer road conditions, lower population density, lower danger, and increased likelihood of travel by the suspect.

In block 335, the dispatch controller 102 then pairs each prioritized intercept point with one of the peer units identified from block 322. Upon pairing each prioritized intercept point, the dispatch controller 102 provides one or more of a peer label notification to each peer unit, navigation directions to the paired prioritized intercept point to each peer unit, and an intercept action to each peer unit (block 336). For example, with reference to FIG. 8, the dispatch controller 102 pairs the first peer unit 306 with the first intercept point 330 and pairs the second peer unit 308 with the second intercept point 332 based on, for example, the relative proximities of the peer units to the respective intercept points. The pairing by the dispatch controller 102 may be based on further information as well, such as the mode of transportation of the responder unit, traffic on route to the intercept point, construction on route to the intercept point, road conditions on route to the intercept point, population center, danger, responder skill set, and experience of the responder. For example, generally, the highest priority intercept point is more likely to be paired with an officer that has more experience and larger skill set, that has a faster car, that is nearby the intercept point, and that will meet less traffic on route to the intercept point. Various other factors may be considered, such as those discussed above as being used in calculating a suitability level of responder units to determine whether to label a responder unit as a pursuit unit (see blocks 268 and 270 of FIG. 6).

The dispatch controller 102 further provides a peer label notification to each of the first peer unit 306 and the second peer unit 308 along with navigation instructions to the respective first intercept point 330 and second intercept point 332. The navigation instructions may include both directions (e.g., straight for 1 mile, then left turn) and speed suggestions (e.g., 75 miles per hour until left turn, then 45 miles per hour) to enable the peer unit to arrive at its associated intercept point before the suspect vehicle 310. Once a peer unit has been paired with an intercept point, the peer unit may also be referred to as an intercept unit.

In addition to navigation instructions to the prioritized intercept point, the coordinated pursuit strategy 290 transmitted to each peer unit may further include intercept action for implementation by the responder unit upon arrival at the intercept point. Example intercept actions may include establishing a barricade, clearing pedestrians, and establishing a clear zone.

In some embodiments, rather than directions to an intercept point, one or more peer units are provided a request to follow the pursuit unit along with navigation instructions or location information for the pursuit unit.

Returning to FIG. 5, after the coordinated pursuit strategy 290 is provided, the dispatch controller 102 determines whether a reevaluation trigger has occurred (block 340). For example, the dispatch processor 110, executing the reevaluation trigger detection module 214, may implement the block 340 to make the determination. The dispatch controller 102 periodically (e.g., multiple times per second, once per second, or once every few seconds) receives data from the responder unit 104 identified as the pursuit unit, which forms and updates part of the received operational data 206. The dispatch controller 102 analyzes the received data to monitor one or more of the factors of the pursuit unit that were used in the calculation of the score in block 268, such as distance to suspect, available fuel, current speed, health of vehicle, and environmental parameters. For example, when a change is detected in one of these factors that exceeds a change threshold associated with the factor, the dispatch controller 102 determines that a reevaluation trigger has occurred.

As an example, when the dispatch controller 102 detects that the pursuit unit has significantly slowed down or detects that a gap between the pursuit unit and the suspect has significantly increased, the dispatch controller 102 may determine that a reevaluation trigger has occurred.

In some embodiments, in addition to or instead of triggering reevaluation based on a change in received operational data 206 from the responder unit 104 identified as the pursuit unit, the reevaluation trigger may occur based on a change in operational data 206 from the responder units 104 identified as peer units, or may occur periodically at certain time intervals.

When a revaluation trigger has occurred, the dispatch controller 102 returns to block 254 of the method 250 to again identify a pursuit unit. Accordingly, the dispatch controller 102 monitors responder units 104 engaged in a suspect pursuit and updates, as appropriate, the responder unit 104 identified as the pursuit unit. This monitoring and updating allows for substituting responder units 104 as the pursuit unit based on changing circumstances in the suspect pursuit. Generally, the monitoring and updating enables the more suitable responder unit 104 to be the identified pursuit unit from which the coordinated pursuit strategy is based.

When a reevaluation trigger is not determined to have occurred in block 340, the dispatch controller 102 returns to block 280 to potentially update the coordinated pursuit strategy. For example, the coordinated pursuit strategy may change if the suspect changes routes. The dispatch controller 102 may loop among blocks 254, 280, and 340 until a suspect is apprehended or the suspect pursuit is ceased, at which point the method 250 ends.

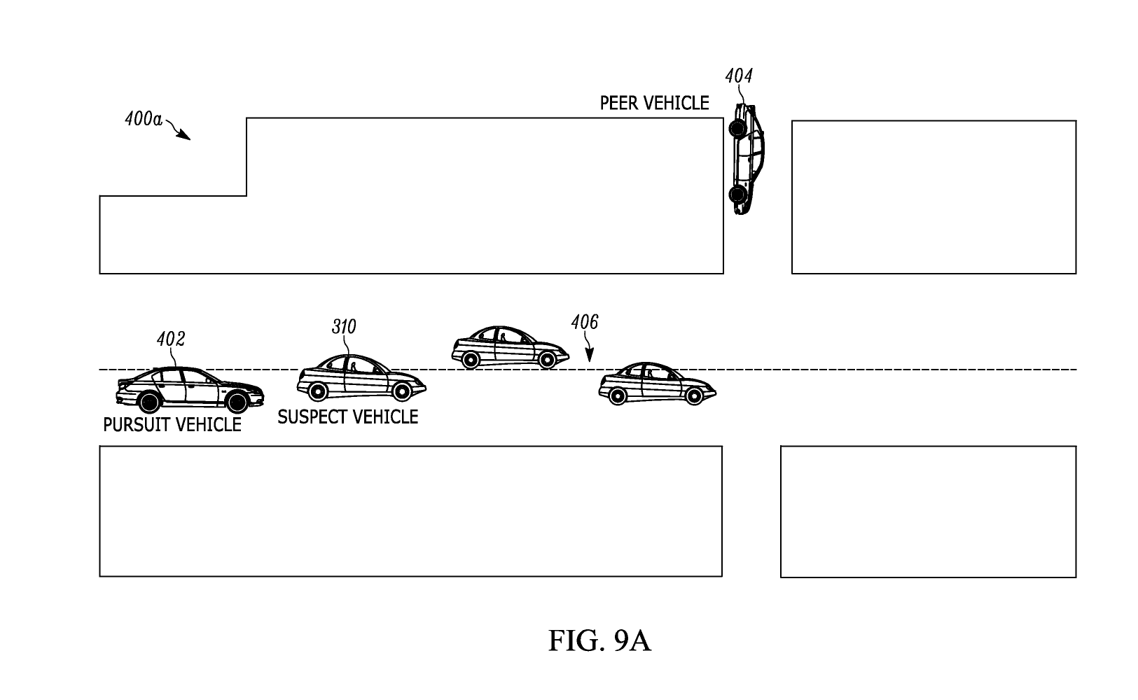

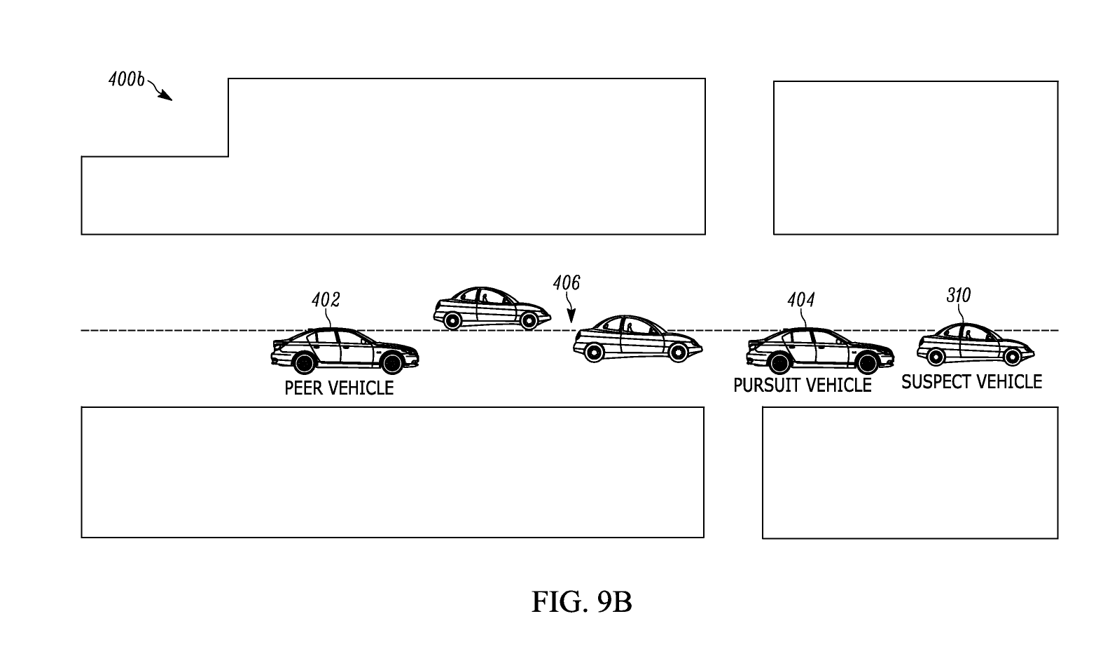

Turning to FIGS. 9A and 9B, an initial pursuit diagram 400a and a handoff pursuit diagram 400b are illustrated, respectively. The diagrams include a first responder vehicle 402, a second responder vehicle 404, traffic 406, and the suspect vehicle 310. Each of the first responder vehicle 402 and second responder vehicle 404 include one of the responder units 104. The dispatch controller 102 executes block 252 of the method 250 (FIG. 5) to determine that a suspect pursuit is active and executes block 254 to identify the first responder vehicle 402 as the pursuit unit and the second responder vehicle 404 as a peer unit. More particularly, in executing block 254, the dispatch controller 102 may implement method 260 of FIG. 6 and may evaluate characteristic data to determine that the first responder vehicle 402 has a higher suitability level than the second responder vehicle 404.

At the time represented by the initial pursuit diagram 400a, a portion of the characteristic data 200 received by the dispatch controller 102 and the resulting suitability score calculated are listed below in Table I.

TABLE I

| Responder Unit | First Responder Unit 402 | Second Responder Unit 404 |
|---|---|---|
| Speed | 80 miles/hour (score = 1) | 90 miles/hour (score = 1) |
| Time in Pursuit | Two minutes (score = 1) | One minutes (score = 1) |
| On-Dash Video | Suspect license plate | No license plate detected |
| Analytics | detected in view frame; | (score = 0) |
| | estimated distance is 30 | |
| | feet (score = 10) | |
| Push-to-Talk | Responder called in chase | Responder called in backup |
| (PTT) Audio | (score = 10) | role (score = 5) |
| Analytics | | |
| Total Score: | 22 | 7 |

In the table, examples of types of characteristic data (e.g., speed) are listed in the left column, and example values (e.g., 80 miles/hour) for the types of characteristic data are listed in the second column for the first responder unit 402 and in the third column for the second responder unit 404. Example scores (e.g., score=1) are also provided for each example value other than the identity of the responder units in the first row. The types of characteristic data listed are exemplary and this and other data may be obtained from the characteristic data 200 (FIG. 4). In some embodiments, in addition to one or more of the types listed in Table I, the types of characteristic data include one or more of the following: transportation mode of responder unit (e.g., on foot, vehicle, motorcycle, horse, bicycle, helicopter, unmanned aerial vehicle, etc.), maximum speed, current speed, defensive capabilities (e.g., reinforced bumper), status (e.g., normal operation or damaged), fuel remaining, unit time-in-shift (i.e., responder fatigue), distance to suspect, vehicle make, vehicle model, vehicle size, vehicle armament, driver/operator experience, driver/operator skill set (e.g., based on passing certification tests or training), and environmental parameters (e.g., traffic light status, topography, road conditions and status, traffic, construction, and weather), among others.

Further, the on-dash video analytics can include multiple score-generating elements, such as license plate detection, distance to suspect (e.g., measured with laser range finder 133 in conjunction with an indication from an officer that the suspect is in view). Additionally, the push-to-talk audio analytics can include multiple score-generating elements, such as whether an officer initially called in the fleeing suspect, whether an officer called in as backup for the suspect pursuit, whether an officer stated another predetermined phrase relevant to suitability level (e.g., “I'm injured”), the frequency of an officer providing a verbal indication of suspect position, the time-since-last verbal indication of suspect position, or whether the officer has a high level of stress in his or her voice.

The handoff pursuit diagram 400b of FIG. 9B illustrates a later point in time in the suspect pursuit than the initial pursuit diagram 400a. In the course of the suspect pursuit, the first responder vehicle 402 was delayed by the traffic 406. Meanwhile, the second responder vehicle 404 has avoided the traffic 406 and become nearer to the suspect vehicle 310. The dispatch controller 102, which is monitoring the characteristic data 200 provided by the responder units 402 and 404, determines that a reevaluation trigger has occurred based on the change in one or more of the parameter values in the characteristic data 200 (block 340, FIG. 5). For example, upon the suspect license plate no longer being detected by the first responder unit 402, the dispatch controller 102 determines that a reevaluation trigger has occurred. In turn, the dispatch controller 102 returns to block 254 (FIG. 5) to again identify the pursuit unit. To identify the pursuit unit, the dispatch controller 102 again implements the method 260 of FIG. 6. However, in this instance, evaluating the characteristic data leads the dispatch controller 102 to determine that the first responder vehicle 402 has a lower suitability level than the second responder vehicle 404. For example, at the time represented by the handoff pursuit diagram 400b, the characteristic data 200 received by the dispatch controller 102 and the suitability score calculated are listed below in Table II. As noted with respect to Table I, the details within Table II including the types of characteristics data, the associated values, and the associated scores, are merely exemplary; other types, values, and scores are used in some embodiments.

TABLE II

| Responder Unit | First Responder Unit 402 | Second Responder Unit 404 |
|---|---|---|
| Speed | 80 miles/hour (score = 1) | 90 miles/hour (score = 1) |
| Time in Pursuit | Seven minutes (score = 1) | One minutes (score = 1) |
| On-Dash Video | No license plate detected | Suspect license plate |
| Analytics | (score = 0) | detected in view frame; |
| | | estimated distance is 30 feet |
| | | (score = 10) |
| Total Score: | 2 | 12 |

Accordingly, the dispatch controller 102 substitutes the second responder vehicle 404 as the pursuit unit based on the updated suitability levels (i.e., scores).

The example pursuit diagrams of FIGS. 8, 9A, and 9B involve vehicles. As noted above, however, the responder units 104 may be associated with officers on foot or other modes of transport, such as on horseback, on bicycle, or unmanned aerial vehicle. Accordingly, the systems and methods described herein similarly apply to suspect pursuits involving other modes of transportation including on foot, by bicycle, by horseback, by unmanned aerial vehicle, or combinations thereof. A particular suspect pursuit may involve responder units using the same mode of transportation (e.g., solely vehicles or officers on-foot), but may also include responder units having different combinations of transportation modes. For example, a suspect pursuit may include a first responder unit that is associated with a first mode of transportation (e.g., on foot, motorcycle, horseback, vehicle, or unmanned aerial vehicle) and a second responder unit that substituted as the pursuit unit (e.g., on a subsequent execution of the block 254 of FIG. 5) may be associated with a second mode of transportation that is different from the first mode of transportation (e.g., a different one of on foot, motorcycle, horseback, vehicle, or unmanned aerial vehicle.).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of assigning roles to responder units in a suspect pursuit, the method comprising:
determining that the suspect pursuit is active, the suspect pursuit including pursuit of a suspect;
identifying a first responder unit of the responder units as a pursuit unit to pursue the suspect;
determining, in response to a reevaluation trigger, to reevaluate assignment of the pursuit unit;
receiving, by a dispatch processor, characteristic data regarding the responder units in response to the reevaluation trigger;
evaluating, by the dispatch processor, the characteristic data to determine a suitability level of each of the responder units to be the pursuit unit; and
substituting, by the dispatch processor, a second responder unit as the pursuit unit based on the suitability levels.

2. The method of claim 1, wherein determining that the suspect pursuit is active includes receiving, from one of the responder units, a user-entered notification that the suspect pursuit is active.

3. The method of claim 1, wherein determining that the suspect pursuit is active includes
receiving, from one of the responder units, operational data including at least one selected from the group consisting of siren status data, emergency light status data vehicle speed data, vehicle acceleration data, user voice data, image data, video data, and audio-visual analytics data; and
determining that the suspect pursuit is active based on the operational data.

4. The method of claim 1, wherein the characteristic data includes received operational data including sensor data and responder information data.

5. The method of claim 1, further comprising: identifying a portion of the responder units as available responder units in response to the reevaluation trigger.

6. The method of claim 5, wherein identifying a portion of the responder units as available responder units comprises:
using an estimated location of the suspect;
receiving operational data including location data for the responder units;
identifying, as the available responder units, the responder units within a predetermined distance of the estimated location of the suspect.

7. The method of claim 1, wherein evaluating the characteristic data to determine a suitability level of each of the responder units to be the pursuit unit includes calculating a score for each of the responder units based on at least one selected from the group consisting of transportation mode, maximum speed, current speed, defensive capabilities, vehicle health, fuel remaining, vehicle make, vehicle model, vehicle size, vehicle armament, distance to suspect, operator experience, driver/operator skill set, unit time-in-shift, and environmental parameters.

8. The method of claim 1, wherein substituting the second responder unit as the pursuit unit based on the suitability levels includes
providing a pursuit label notification to the second responder unit to indicate that the second responder unit is the pursuit unit; and
providing a peer label notification to the first responder unit to indicate that the first responder unit is a peer unit.

9. The method of claim 1, further comprising: estimating a location of the suspect based on operational data including location data from the pursuit unit.

10. The method of claim 1, further comprising:
determining potential routes for the pursuit unit;
identifying a first set of the responder units as peer units;
determining prioritized intercept points based on the potential routes;
pairing each prioritized intercept point with one of the peer units to form a plurality of peer unit and prioritized intercept point pairs; and
for each of the pairs, providing, to the peer unit of the pair, navigation instructions to the prioritized intercept point of the pair.

11. The method of claim 1, wherein the first responder unit is associated with a first mode of transportation and the second responder unit is associated with a second mode of transportation that is different from the first mode of transportation, wherein the first mode of transportation and the second mode of transportation are selected from the group consisting of: on foot, motorcycle, horseback, vehicle, and unmanned aerial vehicle.

12. The method of claim 1, wherein substituting the second responder unit as the pursuit unit based on the suitability levels includes at least one selected from the group consisting of:
providing priority to the second responder unit for quality of service over a communication network;
providing priority to the second responder unit for traffic light control;
highlighting information about the second responder unit on a display of pursuit information; and
controlling a camera of the second responder unit.

13. A dispatch controller comprising:
a transceiver;
a dispatch processor coupled to the transceiver; and
a memory coupled to the dispatch processor and containing instructions that, when executed by the dispatch processor, perform a set of functions comprising:
determining that a suspect pursuit is active, the suspect pursuit including pursuit of a suspect;
identifying a first responder unit of responder units as a pursuit unit to pursue the suspect;
determining, in response to a reevaluation trigger, to reevaluate assignment of the pursuit unit;
receiving characteristic data regarding the responder units in response to the reevaluation trigger;
evaluating the characteristic data to determine a suitability level of each of the responder units to be the pursuit unit; and
substituting a second responder unit as the pursuit unit based on the suitability levels.

14. The dispatch controller of claim 13, wherein determining that the suspect pursuit is active includes receiving, from one of the responder units, a user-entered notification that the suspect pursuit is active.

15. The dispatch controller of claim 13, wherein determining that the suspect pursuit is active includes
receiving, from one of the responder units, operational data including at least one selected from the group consisting of siren status data, emergency light status data vehicle speed data, vehicle acceleration data, user voice data, image data, video data, and audio-visual analytics data; and
determining that the suspect pursuit is active based on the operational data

16. The dispatch controller of claim 13, wherein the memory further includes instructions that, when executed by the dispatch processor, perform a set of further functions comprising: identifying a portion of the responder units as available responder units in response to the reevaluation trigger.

17. The dispatch controller of claim 16, identifying the portion of the responder units as available responder units comprises:
using an estimated location of the suspect;
receiving operational data including location data for the responder units;
identifying, as the available responder units, the responder units within a predetermined distance of the estimated location of the suspect.

18. The dispatch controller of claim 13, wherein substituting the second responder unit as the pursuit unit based on the suitability levels includes
providing a pursuit label notification to the second responder unit to indicate that the second responder unit is the pursuit unit; and
providing a peer label notification to the first responder unit to indicate that the first responder unit is a peer unit.

19. The dispatch controller of claim 13, wherein the memory further includes instructions that, when executed by the dispatch processor, perform a set of further functions comprising: estimating a location of the suspect based on operational data including location data from the pursuit unit.

20. The dispatch controller of claim 13, wherein the memory further includes instructions that, when executed by the dispatch processor, perform a set of further functions comprising:
determining potential routes for the pursuit unit;
identifying a first set of the responder units as peer units;
determining prioritized intercept points based on the potential routes;
pairing each prioritized intercept point with one of the peer units to form a plurality of peer unit and prioritized intercept point pairs; and
for each of the pairs, providing, to the peer unit of the pair, navigation instructions to the prioritized intercept point of the pair.
